(19) United States
(12) Patent Application Publication
(10) Pub. No.: US 2008/0210234 A1
(43) Pub. Date: Sep. 4, 2008

(54) VARIABLE PRESSURE CHAMBER HAVING A SCREW COMPRESSOR

(76) Inventors: William J. O'Brien, Newtown, PA (US); Joseph E. Underwood, Beverly, NJ (US)

Correspondence Address: FOX ROTHSCHILD LLP;PRINCETON PIKE CORPORATE CENTER, 2000 Market Street, Tenth Floor, Philadelphia, PA, 19103, US

(21) Appl. No.: 12/029,916

(22) Filed: Feb. 12, 2008

Related U.S. Application Data
(60) Provisional application No. 60/889,479, filed on Feb. 12, 2007.

(51) Int. Cl. A61G 10/02

(52) U.S. Cl. 128/202.12

(57) ABSTRACT

A variable pressure chamber is provided for operation at hypobaric or hyperbaric pressure. The variable pressure chamber comprises a substantially air-tight enclosure having a sufficient volume to enclose a patient, a sealable opening adapted to provide access to the enclosure, a closure mechanism adapted to seal the sealable opening, a reversible compressor fluidly connected to the enclosure and an outlet flow modulator. A method of treatment of a subject in need thereof using the variable pressure chamber is also provided.

### CROSS-REFERENCE TO RELATED APPLICATIONS

This application claims the benefit of U.S. Provisional Application, Ser. No. 60/889,479, filed on Feb. 12, 2007, incorporated herein by reference in its entirety.

### FIELD OF THE INVENTION

The present invention relates to pressure chambers. More specifically, the present invention relates to variable pressure chambers with reversible compressors.

### BACKGROUND

Hyperbaric oxygen therapy (HBOT) is successfully used for treatment of many medical conditions. HBOT has been shown to be beneficial in treatment of certain non-healing wounds, carbon monoxide poisoning, decompression sickness, severe infections by various anaerobic bacteria, severe anemia, and gas embolisms, among many others.

On the other hand, endurance athletes and high-altitude mountain climbers often use hypobaric chambers to stimulate the body's natural adaptations to altitude, including an increase in the number of red blood cells and enzymes. Since red blood cells carry oxygen to the tissue, athletes benefit from increased delivery of oxygen to the muscles, and mountain climbers can avoid altitude sickness by better utilizing the diminished amount of oxygen found at higher altitudes. In addition, use of the hypobaric therapy may be beneficial in such illnesses as asthma and chronic bronchitis, liver and pancreas diseases, inflammatory diseases and sleep disorders among many others.

In a typical multi-person hyperbaric chamber, a medical grade compressor supplies the primary air at pressure of up to 125 psi. This air then passes through a sequence of conditioning equipment such as an after cooler, a oil separator, an air dryer and some sort of filtration package, before it is held at high-pressure in a sequence of air reservoirs. In order to maintain proper operations, the air reservoirs typically have the capacity of holding at least two times of the air volume that the chamber needs.

From the reservoirs, the pressurized air is passed through another air dryer to remove condensation potentially collected during the cooling process of the air while setting latent in the reservoirs, is passed through a water separator to remove the condensation created by the air dryer, and is passed through some sort of a particulate filtration system. In the last step, the air pressure is regulated down to the operating pressure required by the chamber using a regulator flow valve. Once the chamber is pressurized, no additional, fresh, air is supplied to the chamber. Accordingly, to maintain the air quality within medical guidelines and to keep the patient somewhat comfortable, the internal air of the chamber has to be scrubbed for carbon dioxide and circulated through some form of internal air-conditioning unit.

In addition to requiring multiple stages of equipment and numerous reduction, control, and relief valves to transfer the compressed air from the holding reservoirs into the chamber, the above-described process also causes great discomfort to the patients. While the chamber is being brought up to its operating pressure, adiabatic heat is produced by the recompression of the air inside the chamber. Conversely, during depressurizing of the chamber, the air is rapidly chilled. These drastic changes in temperature are extremely uncomfortable for the occupants of the chamber.

A different set of equipment such as vacuum pumps is necessary if the typical hyperbaric chamber was to be operated as a hypobaric chamber.

Accordingly, there is a need in the art for an improved variable pressure chamber.

### SUMMARY

In one aspect a variable pressure chamber is provided. The variable pressure chamber comprises a substantially air-tight enclosure having a sufficient volume to enclose a patient, a sealable opening adapted to provide access to the enclosure, a closure mechanism adapted to seal the sealable opening, a reversible compressor fluidly connected to inlet of the enclosure and an outlet flow modulator fluidly connected to the outlet of the enclosure.

The reversible compressor is preferably a screw compressor. It has capacity to pressurize the enclosure to pressure between 1 and 6 atmospheres or to depressurize the enclosure to about 0.1 atmospheres. Accordingly, the enclosure is adapted to withstand both hyperbaric and hypobaric pressures.

In another aspect, a method of treatment of subject in need thereof is provided. It comprises placing the subject into a variable pressure chamber as described above, adjusting the pressure in the variable pressure chamber in accordance with the desired effect on the subject, and ventilating the chamber with a fresh air supply while maintaining a target pressure.

The pressure in the variable pressure chamber may be adjusted to at least 1.5 atmospheres to achieve an effect of improving wound healing, increasing oxygen delivery to injured tissue, preservation of damaged tissue, improving infection control, eliminating or reducing effect of toxic substances, eliminating or reducing damage caused by radiation treatment, improvement in circulation, healing of burns.

Alternatively, the pressure in the variable pressure chamber may be decreased to less than at least 0.1 atmospheres in order to enhance fitness level, enhance energy, improve pulmonary and circulation functions.

In yet another aspect, a method for a pressurizing chamber is provided. The method comprises pressurizing the chamber and maintaining the pressure in the chamber while continuously ventilating the chamber with a fresh air supply. The second step may be achieved by continuously pumping air into the chamber; continuously exhausting the air from the chamber to atmosphere; and continuously monitoring the pressure in the chamber and adjusting the input or output to maintain pressure in the chamber.

### BRIEF DESCRIPTION OF THE DRAWINGS

FIG. 1 is a side view of one embodiment of the variable pressure chamber.

FIG. 2 shows an embodiment of the variable pressure chamber having a dual lock entry and an air-lock.

FIG. 3 presents an embodiment flow chart.

### DETAILED DESCRIPTION

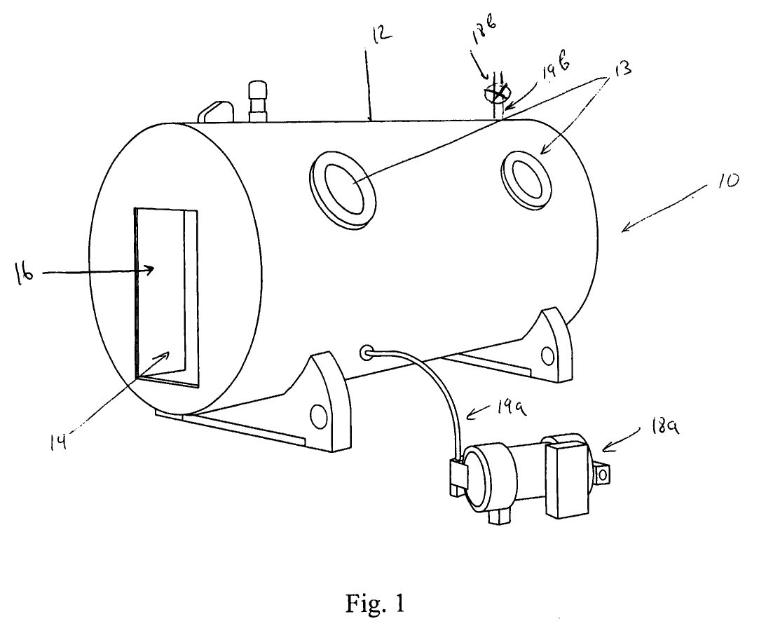

A variable pressure chamber 10 is shown in FIG. 1. Such chamber comprises a substantially air-tight enclosure 12 having a sufficient volume to enclose a patient, a sealable opening 14 adapted to provide access to the enclosure, a closure mechanism 16 adapted to seal the sealable opening, a reversible compressor 18a fluidly connected to the inlet of the enclosure 12, and an outlet flow modulator 18b fluidly connected to the outlet of the enclosure 12.

The enclosure 12 is preferably a vertically-oriented, generally cylindrical structure. The enclosure should be constructed in accordance with guidelines for pressure vessels set by American Society of Mechanical Engineers. Compliance with these guidelines should ensure that the enclosure 12 is capable of withstanding both hyperbaric and hypobaric environments. Preferably, the enclosure is constructed from steel or aluminum.

The enclosure 12 is adapted to enclose a patient. Although the enclosure may be designed for a single patient, in the preferred embodiment, it may have a sufficient volume to permit treatment of several patients simultaneously. In some embodiments, the enclosure may also have room for medical personnel who can observe or assist the patients undergoing the treatment. Since patients may have to spend extended period of time inside the enclosure, it may be desirable to place chairs in the enclosure to increase patients comfort. Additionally, to accommodate more critical, i.e. bedridden, patients the enclosure may also include medical beds or stretchers. In some embodiments, exercise equipment may be placed inside the enclosure.

Referring to FIG. 1, the enclosure 12 may further comprise at least one window 13 disposed along the walls of the enclosure 12. In some embodiments the windows may also be placed on the roof of the disclosure. It is important that the windows do not allow the outside air to enter the enclosure when the enclosure is under hypobaric condition or to leak out from the enclosure when operating under hyperbaric conditions. Windows for pressure vessels are well known as illustrated by, for example, U.S. Pat. Nos. 6,639,745 or 4,986,636, incorporated herein by reference.

Access to the enclosure 12 may be gained through a sealable opening 14. Preferably, the sealable opening is designed to allow easy access to the enclosure 12. Thus preferably, the sealable opening is large enough to allow users to enter upright without excessive crouching. Also, preferably, it is sufficiently wide to enable medical personnel to bring patients on stretchers into the chamber, if necessary.

The sealable opening 14 may be closed by various types of closure mechanisms 16 that have been developed over the years. Suitable closure mechanisms are described, for example, in U.S. Pat. Nos. 5,433,334; 5,327,904; 6,352,078, which are incorporated herein by reference in their entirety. In addition, U.S. Pat. No. 7,100,604, incorporated herein by reference in its entirety, teaches a latching system and method specifically designed for dual purpose pressure chambers.

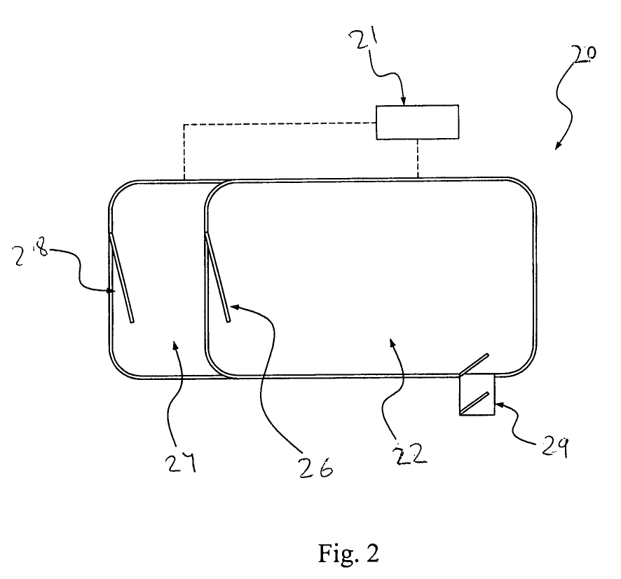

In some embodiments, the chamber may include a dual lock entry. The dual lock entry allows easy access in and out of the chamber while the chamber is under pressure other than atmospheric. Referring to FIG. 2, the variable chamber 20 comprises a main enclosure 22 and an entrance enclosure 24. Once users enter the main enclosure 22, it is closed using an interior closure mechanism 26. The main enclosure may then be brought to the desired pressure using reversible compressor 21. If some of the users need to leave while others are still receiving treatment, the entrance enclosure 24 is sealed by closing an exterior closure mechanism 28 and the entrance enclosure 24 is brought to the same pressure as the main enclosure 22. The interior closure mechanism 26 may then be opened so the patients may move from the main enclosure 22 to the entrance enclosure 24. The interior closure mechanism 26 is then closed and the pressure in the entrance enclosure 24 is brought to the atmospheric pressure. Next, the exterior closing mechanism 28 is opened to permit the user to leave the entry enclosure 24. To allow users to enter the main enclosure 22 during treatment, the process is reversed. In some embodiments, the main entrance enclosure may be used to accommodate patients if the main enclosure 22 is full.

In some embodiments in addition to or instead of the dual lock entry, the variable pressure chamber may also include an air-lock. Such airlock 29 shown in FIG. 2 allows passing of the small objects in and out of the chamber without changing the pressure in the chamber when the chamber is maintained at pressures other than atmospheric. The airlock 29 operates based on the same principal as the dual lock entry. Since the volume of the air-lock is much smaller than the volume of the entrance enclosure, it is more economical to use the air-lock to pass small objects, such as food, water, medicine, or medical instruments, in and out of the operating chamber.

To decrease the risk of fire or explosion, the chamber may preferably be pressurized with air instead of pure oxygen. In some embodiments, the users may be given individual oxygen masks that supply pure oxygen and remove the exhaled gas from the chambers. Suitable oxygen masks may simply cover the mouth and nose or they may be a type of flexible, transparent helmet with a seal around the neck. Accordingly, the chamber may also need to include a source of pure oxygen such as oxygen tank stored either inside or outside the chamber.

Preferably, the chamber also includes features that ensure the safety and comfort of the users. Such features are known and may include, but are not limited to, lights, temperature control, humidity control, pressure relief valves, fire suppression systems, intercoms and combinations thereof.

Referring back to FIG. 1, the radiation chamber 10 also includes a reversible compressor 18a fluidly connected to the enclosure 12 via a hose or a pipe 19a and an air flow modulator 18b connected to the enclosure by a hose or a pipe 19b. Suitable compressors have capability to pressurize the enclosure to pressure between 1 and 6 atmospheres or to depressurize the enclosure to about 0.1 atmospheres, as desired for specific applications. Preferably, a high speed modulator valve is used such that it can fully open and close in less than one second. Flow modulators are well known in the art and are described, for example in, Control Valve Handbook, 4th edition, Fisher Controls International, (2005), incorporated herein by reference in its entirety. One suitable example of an outlet modulator valve is an electro-pneumatic positioner manufactured by Radius, LLS, Milford, Mich. (part # RX-1000 series; R-AD-012) . A person with ordinary skill in the art is undoubtedly capable of selecting a compressor and an outlet flow modulator that in combination may enable the target pressure to be achieved and maintained in the chamber, while allowing the chamber to be continuously ventilated with fresh air supply.

In the preferred embodiment, the reversible compressor comprises a screw compressor. Screw compressors are typically used to transfer dry bulk materials such as cement, flour, salt, and milk powder, and to convey, boost or compress a myriad of inert, corrosive, and explosive gases found in chemical plants and refineries. Applicants, however, unexpectedly found that using screw compressors for pressure chambers results in a number of benefits. These benefits include, but are not limited to: enabling chamber operation under both hypobaric and hyperbaric conditions without need for additional equipment; enabling user to pressurize and use the air for the chamber in one continuous action instead of pressurizing the air to high PSI, storing it, and using multiple stages of conditioning equipment to make it suitable for human use; reducing a quantity of required equipment; eliminating patient discomfort; allowing fresh air circulation.

Generally, a screw compressor may supply a constant high volume of air that maintains its flow curve against any restriction until it reaches its design high pressure limit. In one embodiment, by supplying the chamber's ambient air at a constant flow rate and restricting its exhaust capacity flowing through the chamber by use of a high-speed modulating valve, the end result is an extremely controllable and sustainable rate of pressurization. Alternatively, the exhaust capacity may be maintained at a constant value, and the chamber may be pressurized by varying the flow rate of air from the screw compressor. Once the target pressure value has been achieved, it can be by use of programmable industrial automation controls.

Preferably, by screw compressor supplying a constant flow (CFM) of air during the entire pressure curve of the treatment, the system computers may be capable of continuously controlling the target pressure to plus or minus 0.01 PSI, while continuously ventilating the chamber with a fresh air supply. In other words, when the system reaches a pressurized steady state, it may be maintained by adjusting the compressor and the outlet flow modulator so the amount, mass, of fresh air flowing into the chamber is equal to the amount of air flowing out from the chamber and exhausted out of the system. The term “fresh air” means the air supplied by the compressor that has not been previously used to pressurize the chamber.

Accordingly, in one embodiment the pressure in the chamber is maintained by continuously pumping air into the chamber; continuously exhausting the air from the chamber to atmosphere; and continuously monitoring the pressure in the chamber and adjusting the input or output to maintain pressure in the chamber.

Screw compressors may also be used as vacuum pumps. By simply reversing the rotation of the screw, the hyperbaric chamber may be turned into a hypobaric chamber.

Screw compressors supply dry, oil free air at temperatures of up to 340° F. sterilizing the air, which may then be chilled through the use of a flow controlled chilled water source, supplying a high-efficiency heat exchanger that lowers the adiabatic heat of compression to a comfortable 55 to 85° F. Any condensation created from the process may be easily collected and removed. Mist filtration preferably removes 99.9% of any particular matter 1/10 of a micron or larger. By preconditioning the air temperature before it ever reaches the hyperbaric chamber, the occupants never feel an uncomfortable rise or fall of the temperature inside the chamber.

Any known screw compressor may be employed. One suitable example includes, but is not limited to, Aerzen Screw Compressor units DELTA SCREW VM/VML manufactured and sold by Aerzen USA, Coatesville, Pa. These compressors are specifically designed for dry and clean compression of air and neutral gases. They may be used for oil-free compression of air and inert gases up to 8500 cfm (14,400 m³/h) and 30 psig or 5600 cfm (9500 m³/h) up to 51 psig. These machines may also be used as very efficient dry screw vacuum pumps down to 85% continuous vacuum or 25.5″ Hg.

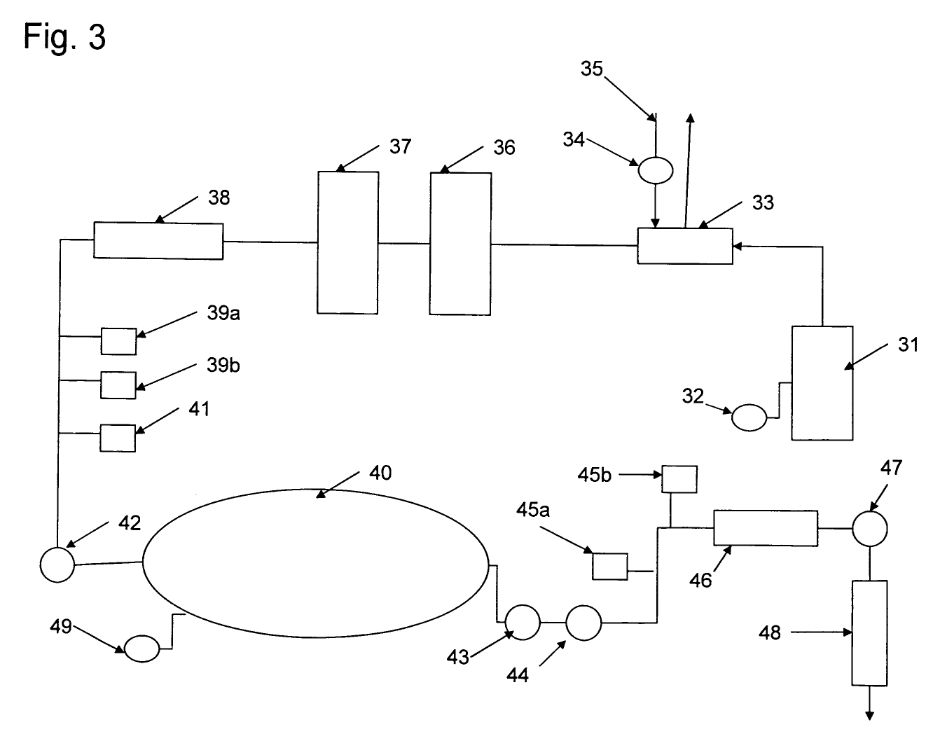

FIG. 3 presents a non-limiting embodiment process flow chart for a variable pressure chamber with a screw compressor system 30. The oil free air may exit the compressor 31, which may include a release valve 32, at approximately 340° F. and 30 psi. The high temperature sterilizes the air immediately destroying any biological or microbial life. The air may then be passed through a non-restrictive heat exchanger 33 that drops the air temperature to about 65° F. Conversely, during the depressurization cycle of the process, air supply may be preheated to maintain the internal temperature of the chamber at a comfortable 70 to 72° F. The temperature of the air may be controlled by a modulating valve 34 which controls the flow rate of chilled water supply 35. Controlling the temperature in this manner is possible because the air is only compressed one time in the chamber and then is maintained at that pressure through control of the constant flow. On the contrary, in a typical chamber, the temperature of the air in the chamber cannot be controlled because the air is recompressed inside the chamber.

The air supply is then passed through a pre-filter 36 to remove any condensation formed by the rapid chilling process and then through a mist eliminator 37 to remove sub-micronic particles and to reduce residual moisture content. For this application, it is desirable to use a mist eliminator capable of removing particles at a rate of 99.98% of particles 1/10 micron and larger and of reduces any residual moisture content down to 0.5 ppm. Optionally, the airflow may be passed through an acoustic attenuator, silencer, 38 that may reduce any sound generated in the compression or filtration process to less than 70 dB. The air is then passed through a series of controls 39, described below, and into the chamber 40 through a pressure gauge 41 and a check valve 42. After the chamber, the air is passed through air velocity fuse 43, isolation valve 44, a series of secondary controls 45, a silencer 46, an outlet flow modulator valve 47, and another silencer 48 before it is exhausted from the system. The pressure in the chamber may be achieved and controlled by a modulator valve 47 in combination with the compressor 31. Preferably, a high speed modulator valve is used so it can fully open and close in less than one second. The chamber may also include an emergency relief valve 49.

The flow rate and physical characteristics of air may be controlled by two sets of controller 39 and 45. A primary set of controllers 39 comprises a temperature sensor 39a and pressure sensor 39b. The secondary set of controllers 45 comprises temperature sensor 45a and pressure sensors 45b. In addition, the exhaust air may also be sampled using an air quality system 51 for oxygen percentage and carbon dioxide. These data is supplied to the controller unit (not shown) that may adjust the air flow rate to achieve desired pressure, temperature, etc. Any type of controllers may be used for the methods described herein. Preferably, a feedback controller, such as for example a proportional-integral (PI) or a proportional-integral-derivative controller (PID controller), is utilized. Preferably, continual updates from the processor are taken at a speed of 5 ms which enables precise control of the airstream.

In another aspect, a method of treatment of a subject in need thereof is provided. The method comprises placing the subject into a variable pressure chamber as described above adjusting the pressure in the variable pressure chamber in accordance with desired effect on the subject, and ventilating the chamber while maintaining the target pressure. The term “treatment” means any treatment that enhances physical health of the subject. It includes treatment of existing disease or injury and prevention of injuries or disease. It also includes the use of the chamber by healthy individuals such as endurance athletes or mountaineers to further improve their condition.

The pressure in the variable pressure chamber may be set in accordance with desired effect on the subject. Such pressure will be referred to herein as a target pressure. The pressure in the variable chamber may be increased to up to 6 atmospheres, preferably between about 1.5 and 3 atmospheres, and more preferably between about 2.0 to 2.4 atmospheres, this is in order to improve wound healing, increase oxygen delivery to injured tissue, preserve of damaged tissue, improve infection control, eliminate or reduce effect of toxic substances, eliminate or reduce damage caused by radiation treatment, improve circulation, brain-damage from near hanging, near drowning, cyanide or carbon monoxide poisoning, heal thermal burns or combinations thereof. There are currently 13 approved Medicare indications and 65 to 70 indications being treated worldwide, including stroke, autism, multiple sclerosis, dementia, and Lyme disease to reference just a few. Alternatively, the pressure in the variable pressure chamber may be decreased to 0.1 atmospheres, preferably 0.2 to, for example, enhance fitness, enhance energy, improve pulmonary and circulation functions, including use in any medical treatment necessitating the ability to generate a hypoxic state in the patient.

In another embodiment, the variable pressure chamber may be used in combination with chemotherapy. Studies have shown that treatment of patients with hyperbaric oxygen before, during or after chemotherapy treatment may provide many benefits such as increasing the effectiveness of the chemotherapy treatment or decreasing healing time after the treatment. Accordingly, a method for treating a patient before, during, or after chemotherapy is provided. The method comprises placing the subject into a variable pressure chamber as described above, increasing the pressure in the variable pressure chamber, and ventilating the chamber while maintaining target pressure.

All publications cited in the specification, both patent publications and non-patent publications are indicative of the level of skill of those skilled in the art to which this invention pertains. All of these publications are herein fully incorporated by reference to the same extent as if each individual publication were specifically and individually indicated as being incorporated by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A variable pressure chamber comprising:
a substantially air-tight enclosure adapted to accept a patient and having an inlet and an outlet;
a sealable opening adapted to provide access to the enclosure;
a closure mechanism adapted to seal the sealable opening;
a reversible compressor fluidly connected to the inlet of enclosure; and
an outlet flow modulator fluidly connected to the outlet of the enclosure.

2. The chamber of claim 1 wherein the reversible compressor and the outlet flow modulator in combination maintain a target pressure in the enclosure while continuously ventilating the chamber with a fresh air supply.

3. The chamber of claim 1 wherein the reversible compressor is a screw compressor.

4. The chamber of claim 1, wherein the enclosure is adapted to withstand hyperbaric or hypobaric pressures.

5. The chamber of claim 1, wherein the reversible compressor has capacity to pressurize the enclosure to pressure between about 1 and about 6 atmospheres.

6. The chamber of claim 1, wherein the reversible compressor has capacity to depressurize the enclosure to about 0.1 atmospheres.

7. The chamber of claim 1, wherein a sealable opening comprises a sealable door.

8. The chamber of claim 1 further comprising an air lock for entry of the enclosure.

9. A method of treatment of subject in need thereof comprising:
placing the subject into a variable pressure chamber comprising:
a substantially air-tight enclosure adapted to accept a patient and having an inlet and an outlet;
a sealable opening adapted to provide access to the enclosure;
a closure mechanism adapted to seal the sealable opening;
a reversible compressor fluidly connected to inlet of the enclosure;
an outlet flow modulator fluidly connected to the outlet of the enclosure;
adjusting the pressure in the variable pressure chamber in accordance with desired effect on the subject; and
continuously ventilating the chamber with a fresh air supply while maintaining a target pressure in the enclosure.

10. The method of claim 9 wherein the reversible compressor comprises a screw compressor.

11. The method of claim 9 wherein continuously ventilating the chamber with a fresh air supply while maintaining a target pressure in the enclosure comprises adjusting the reversible compressor and the outlet flow modulator so the mass of air into the chamber equals the mass of air out of the chamber.

12. The method of claim 9, wherein the step of adjusting the pressure in the variable pressure chamber in accordance with desired effect on the subject comprises increasing the pressure in the variable pressure chamber to at least 1.5 atmospheres.

13. The method of claim 9, wherein the step of adjusting the pressure in the variable pressure chamber in accordance with desired effect on the subject comprises decreasing the pressure in the variable pressure chamber to less than at least 0.5 atmospheres.

14. The method of claim 13, wherein the desired effect is selected from the group consisting of enhanced fitness, enhanced energy, improving pulmonary and circulation functions.

15. A method for treating a patient before, during, or after chemotherapy comprising:
placing the patient into a variable pressure chamber, wherein the chamber comprises:
a substantially air-tight enclosure adapted to accept a patient and having an inlet and an outlet;
a sealable opening adapted to provide access to the enclosure;
a closure mechanism adapted to seal the sealable opening;
a reversible compressor fluidly connected to the inlet of the enclosure;
an outlet flow modulator fluidly connected to the outlet of the enclosure;
increasing the pressure in the variable pressure chamber; and
continuously ventilating the chamber with a fresh air supply while maintaining a target pressure in the enclosure.

16. The method of claim 15, wherein the pressure is increased to between about 1.5 and 3 atmospheres.

17. The method of claim 15, wherein the subject is exposed to increased pressure for 30 minutes at a time.

18. The method of claim 15 wherein the reversible compressor comprises a screw compressor.

19. A method for pressurizing a chamber, the method comprises:
a) pressurizing the chamber; and
b) maintaining the pressure in the chamber while continuously ventilating the chamber with a fresh air supply.

20. A method of claim 19 wherein step b) comprises:
continuously pumping air into the chamber;
continuously exhausting the air from the chamber to atmosphere; and
continuously monitoring the pressure in the chamber and adjusting the input or output to maintain pressure in the chamber.
